(19) United States
(12) Patent Application Publication
(10) Pub. No.: US 2005/0269794 A1
(43) Pub. Date: Dec. 8, 2005

(54) Skateboard with variable rate suspension

(76) Inventor: John Richard Lukes, Thousand Oaks, CA (US)

Correspondence Address: JOHN RICHARD LUKES, 1728 SUNOAK PLACE, THOUSAND OAKS, CA, 91320, US

(21) Appl. No.: 10/862,081

(22) Filed: Jun. 7, 2004

(51) Int. Cl. B62M 1/00

(52) U.S. Cl. 280/87.042

(57) ABSTRACT

This invention consists of a riding deck, adjustable bias block, flat spring, and two adjustable compression springs, and a pair of roller trucks that are fastened to the flat spring at opposite ends. When the rider stands on the deck and applies pressure to either side of said deck; there will be a directional change of the truck wheels. Depending on the weight of the rider, the distance between the top of the deck and the bottom of the truck wheels can e adjusted by increasing the tension on the two compression springs located at the midpoint of the flat spring. This increased tension on the compression springs causes the opposite ends of the flat spring to deflect away from the underside of the ridding deck. This unique design allows the flat spring to change from a static parallel flat configuration of an arc configuration. Now as the tension is increases on the compression springs, the distance between the underside and the bottom of the truck wheels which are at opposite ends of the flat spring increases. Due to the uniqueness the compression spring design, the rider in extreme maneuvers can tilt the deck so that the flat spring will change its position in relationship to the underside of the deck. The rotation of the flat spring along the axis of the underside of the riding deck is what helps a slalom rider achieve the tight down hill racing maneuver of darting in and out between a set of cones much like a downhill snow ski slalom racer. This maneuver with the flat spring changing its position allows the rider to lean his or her body at extreme angles and allow the truck wheels to stay planted on the riding surface.

### BACKGROUND OF THE INVENTION

1.) This Invention Pertains to the Field of Skateboarding.

The present invention pertains to a skateboard that has compression spring design that will allow a flat spring to independently rotate about the axis of the underide of the skateboard deck.

2.) Description of Prior Art

The standard skateboard consists of a deck (platform) that the rider stands on and a set of wheels that are mounted to the underside of the deck. By applying pressure to either side of the deck, the rider can cause a direction change of the board. The deck is generally made out of hard wood, plywood or is a molded extrusion. The deck is generally longated with both ends tapered upwards to allow for fancy footwork.

The present invention pertains to a skateboard that has adjustable height rise and adjustable compression coil over springs. My invention will allow the rider to adjust the rotational position of the flat spring whale leaving the wheels in full contact with the riding surface.

### SUMMARY OF INVENTION

It is the object of the present invention to provide adjustable suspension to a skateboard. Using my compression spring design will allow a flat spring to independently rotate about the axis of the underside of the deck. This flexibility allows the rider to perform more versatile fancy tricks and improves performance maneuverability in slalom down hill racing.

Issue is taken with U.S. Pat. No. 4,123,080 showing a flat spring # 54 secured flush to the underside of # 12 platform. Patent inventor, Agaganian did not go far enough to imagine a toally different concept of independent rotation of the the # 12 platform.

U.S. Pat. No. 3,954,279 (inventor Guerr) shows a compression spring # 41 which would only affect the springback of the # 10 deck.

The rotational design in my invention is neither envisioned nor imagined by either Agajanian or Guerr.

### BRIEF DESCRIPTION OF DRAWINGS

FIG. 1 prior art

FIG. 2 shows a preferred embodiment of the present invention.

FIG. 3 shows a preferred embodiment of the bias block with side view.

FIG. 3A shows a preferred embodiment of the bias block top view.

FIG. 4 shows a preferred embodiment of the hardware to attach the bias block to the skateboard deck.

FIG. 5 shows a preferred embodiment of the compression spring assembly.

FIG. 6 shows a preferred embodiment of the flat spring with location of 2 (two)-compression springs.

FIG. 7 shows side view location of 2 compression spring assemblies.

FIG. 8 shows T-Nut and hardware screw.

FIG. 8A shows an end view of T-Nut.

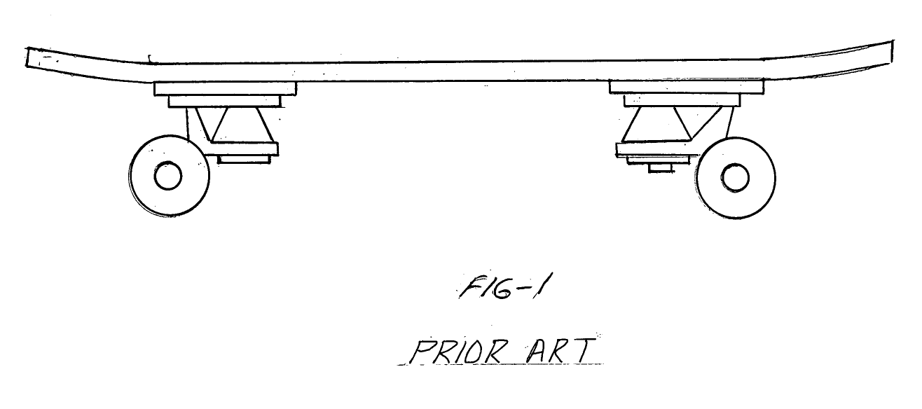

### DETAILED DESCRIPTION OF INVENTION

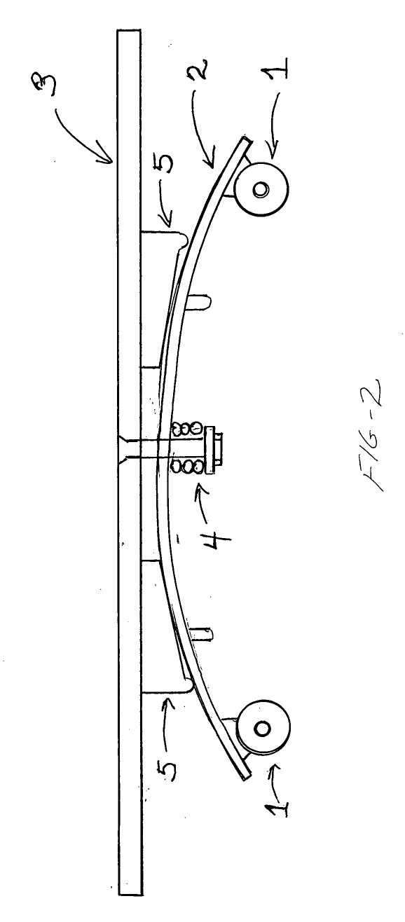

FIG. 2 shows the complete skateboard. The skateboard consists of a deck 3, bias block assembly 5, flat spring 2, and 2 compression spring assemblies 4, a pair of wheels 1.

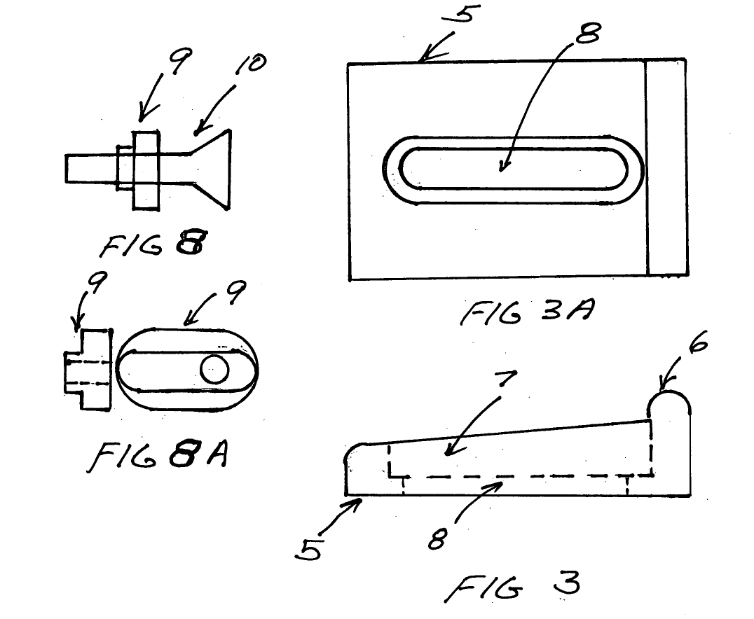

FIG. 3 shows the bias block 5 tapered to one end to allow the flat spring to compress close to the underside of the deck. Radius 6 across the bias block 5 allows the flat spring a support surface as the flat spring bends over it. The bias block 5 has a pocket 7 and slot 8 to allow for the hardware screw 10 and threaded tee-nut 9 to fasten the bias block 5 to the deck.

FIG. 3A shows the topside view of the bias block and the slotted pocket 8. This pocket allows the T-Nut (item 9 of FIG. 8A) to slide back in forth with out rotating.

FIG. 4 shows a fastener 10 with a threaded T-Nut 9. The end of the fastener 10 has no threads and protrudes through a hole in the flat spring 2 to keep the flat spring on center with the deck 3. As the fastner 10 is loosened, the bias block 5 is able to slide back and forth.

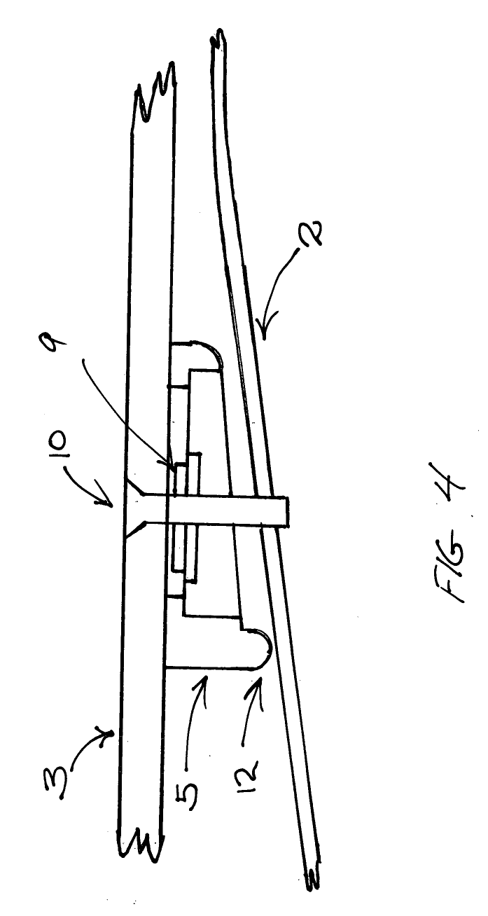

FIG. 5 shows the deck 3 mounted to the compression spring 15 and hardware 17,13,14,16. As nut 16 is threaded down, the pressure compresses the middle of the flat spring 2 and thus allows the ends of flat spring 2 to rise giving more distance between the top of the deck 3 and the riding surface. Item 13 is a combination spring stop for compression sping 15 and guide sleeve that slips through flat spring 2. Also spring stop 13 is a mounting point that allows flat spring 2 to move up and down by either by adjusting position of nut 16 or by weight of the rider. Force of the weight of the rider that caauses the flat spring 2 to push down against the resistance of compression springs 15 causing a dampening effect. Item 14 is a modified spring washer that keeps compression spring 15 on center with fastener 17.

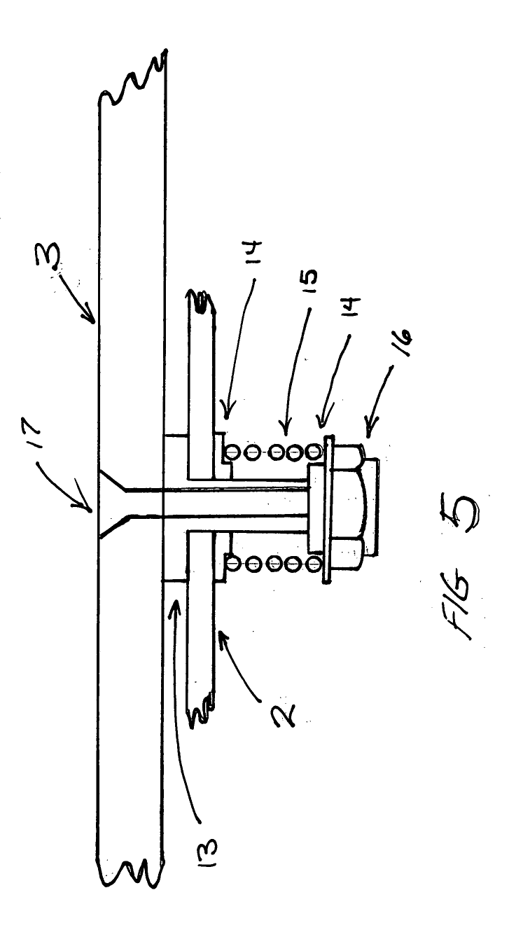

FIG. 6 shows flat spring 2 with two mounting holes for compression assembly 4 under deck 3.

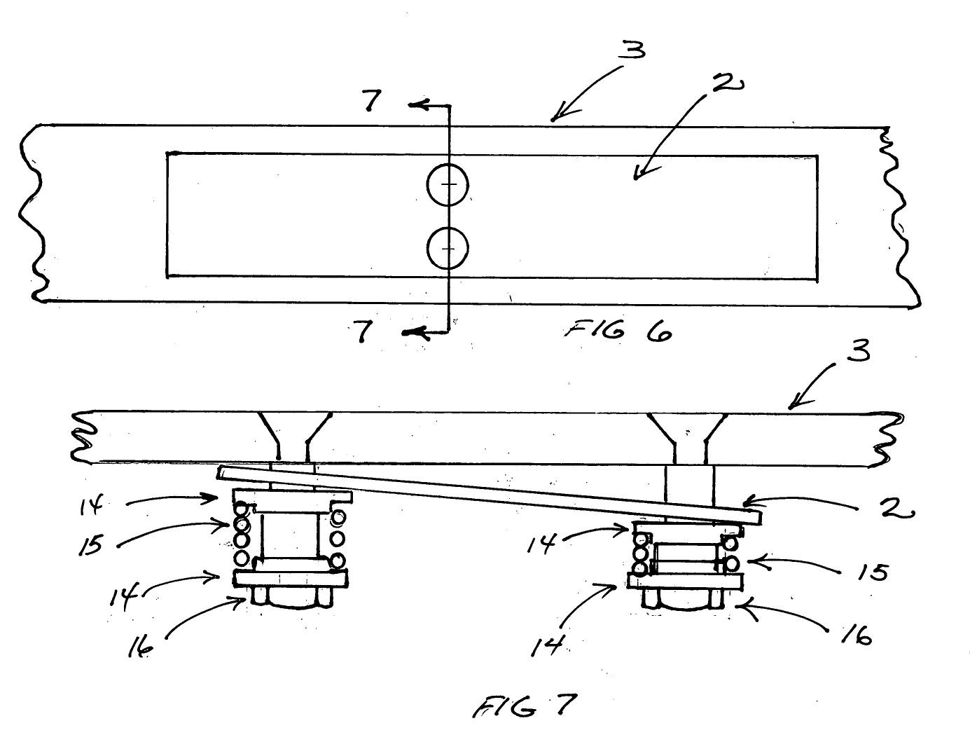

FIG. 7 shows a cross secion view of flat spring 2 as said spring rotates about the axis of the underside of deck 3. When in operation compression assembly (FIG. 5 detail) of said assembly, is either compressed of decompressed depending on which side of the deck 3 the riders weight is placed on. This independent rotation of flat spring 2 allows the rider to tilt his or her body as extreme angles to give the rider a distinct advantage in making quick, sharp executions of right and left turns between cones in slalom racing.

FIG. 8 shows T-Nut item 9 and hardware item 10 mounting configuration.

FIG. 8A shows configuration of T-Nut item 9 shape with threaded hole offset at one end so that T-Nut can be rotated 180 degrees.

Although the present invention has been shown in the preferred embodiment, it will be appreciated by those skilled in the art that modifications to this invention may be made without departing from the scope of the invention.

1. A skateboard comprising:
A skateboard with an enhanced compression spring suspension. A compression spring assembly designed to allow a flat spring to independently rotate about the axis of the underside of a skateboard. This rotation of the flat spring along the axis of the underside of the riding deck is what helps a slalom rider achieve the tight down hill racing maneuver of darting in and out between a set of cones much like a snow ski slalom racer. This maneuver with the flat spring changing position allows the rider to lean his or her body at extreme Angles and allow the truck assembly wheels to stay planted to the ground. This flexibility allows the rider to perform more versatile fancy tricks and improve performance maneuverability in slalom down hill racing.
